(19) United States
(12) Patent Application Publication
(10) Pub. No.: US 2015/0183308 A1
(43) Pub. Date: Jul. 2, 2015

(54) ROOF HATCH SYSTEM

(71) Applicant: Gloria M. Buley, Shokan, NY (US)

(72) Inventors: Gloria M. Buley, Shokan, NY (US); Wesley S. Buley, Shokan, NY (US); Travis C. Buley, Shokan, NY (US)

(21) Appl. No.: 14/585,513

(22) Filed: Dec. 30, 2014

Related U.S. Application Data
(60) Provisional application No. 61/923,085, filed on Jan. 2, 2014.

(51) Int. Cl. B60J 7/16; B60J 7/185

(52) U.S. Cl. CPC B60J 7/1642; B60J 7/185

(57) ABSTRACT

Certain embodiments provide a roof hatch system that includes a hatch housing, a hatch, a hatch latch, a hatch opening mechanism, and an interior hatch bar. The hatch is pivotably coupled to the hatch housing by at least one hinge. The hatch latch is operable to detachably secure the hatch to the hatch housing. The hatch opening mechanism is operable to release the hatch latch. The interior hatch bar is coupled to the hatch opening mechanism and is operable to activate the hatch opening mechanism in response to a received force toward the hatch to pivot the hatch from a closed position to an open position. In various embodiments, the interior hatch bar is illuminated. In certain embodiments, the roof hatch system includes a collapsible ladder system integrated with and/or coupled to the hatch housing. In a representative embodiment, the roof hatch system includes an escape assist handle system.

### CROSS-REFERENCE TO RELATED APPLICATIONS/INCORPORATION BY REFERENCE

The present application claims priority under 35 U.S.C. §119(e) to provisional application Ser. No. 61/923,085 filed on Jan. 2, 2014, entitled “Roof Hatch System.” The above referenced provisional application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present invention relates to roof hatch systems. More specifically, the present invention relates to a roof hatch system for school buses, trailers, and other large vehicles that provides ventilation and an emergency escape route when other egress routes are unusable or unavailable.

### BACKGROUND OF THE INVENTION

Every year, adult and adolescent passengers are injured in school or transit bus related accidents. During an accident, an emergency roof hatch may be used to escape, particularly when the primary exit door, the rear exit door, and/or any side emergency exit doors or windows may become blocked or unusable. Existing roof hatch systems can be difficult to find, reach, open, and climb out.

Existing roof hatches may be difficult to find. Particularly, existing roof hatch systems can include a red marker light signifying where the roof hatch is positioned on the bus; however, the marker light is not part of the roof hatch. As such, passengers attempting to open the hatch in a smoke-filled or dark vehicle may not be able to identify where the opening mechanisms are positioned and/or how to operate the opening mechanisms.

Current roof hatches may be difficult to reach. On average, a school bus roof is seventy six (76) inches above the bus floor and access to a roof hatch is typically eighty (80) inches above the floor. According to Center for Disease Control and Prevention (CDC), the average height of adult males and females is 69.3 inches and 63.8 inches, respectively (CDC 2012). Additionally, the height for the 50^{th} percentile of eleven year olds is approximately 56.4 inches (CDC 2000). Thus, an average grown male would have to reach about ten (10) inches above their head, an average grown female would have to reach about seventeen (17) inches above their head, and an average eleven year old would have to reach a about twenty-four (24) inches above their head to access a roof hatch. Assuming an average reach of approximately fifteen (15) to twenty (20) inches above the head, shorter males, most females, and most eleven year olds may have difficulty accessing and reaching a roof hatch in a school bus. Passengers having difficulty accessing a roof hatch may stand on bus seats or even climb on other passengers in panicked situations.

Existing roof hatches can be difficult to open. During the normal operation of transit and school buses, passengers are rarely, if ever, instructed how to use a roof hatch. As a result, the first time a passenger encounters opening or closing a roof hatch can be during an emergency situation. Current roof hatches are typically opened by turning or rotating a knob or handle, which can pose a serious problem in emergency situations when passengers may panic and push each other. In particular, attempting to rotate a knob prior to disengaging a lock of a current roof hatch system as passengers are pushing and shoving to gain access to the roof hatch may preclude passengers from escaping.

It may be difficult to climb out of existing roof hatch systems. Passengers typically climb out of current roof hatches by reaching overhead, grabbing the roof of the bus, and hoisting themselves out of the bus. Many people do not possess the upper body strength to hoist their body out of the bus through existing roof hatch systems. As such, passengers in emergency situations have improvised by climbing on each other and the bus seats, which can still be difficult as well as dangerous.

Further limitations and disadvantages of conventional and traditional approaches will become apparent to one of skill in the art, through comparison of such systems with some aspects of the present invention as set forth in the remainder of the present application.

### SUMMARY OF THE INVENTION

Certain embodiments of the present technology provide a roof hatch system, substantially as shown in and/or described in connection with at least one of the figures.

These and other advantages, aspects and novel features of the present invention, as well as details of an illustrated embodiment thereof, will be more fully understood from the following description and drawings.

### BRIEF DESCRIPTION OF THE DRAWING(S)

FIG. 1 depicts a top view of exemplary roof hatch system, in accordance with an embodiment of the invention.

FIG. 2 depicts an elevation view of an exemplary roof hatch system with an air ventilation vent in an open position, in accordance with an embodiment of the invention.

FIG. 3 depicts an elevation view of an exemplary roof hatch system with an air ventilation vent in a closed position and a hatch latch in an open position, in accordance with an embodiment of the invention.

FIG. 4 depicts a bottom perspective view of an exemplary roof hatch system, in accordance with an embodiment of the invention.

FIG. 5 depicts a bottom perspective view of an exemplary roof hatch system with an escape ladder deployed and a hatch in an open position, in accordance with an embodiment of the invention.

FIG. 6 depicts a perspective view of an exemplary roof escape assist handle in an extended position, in accordance with an embodiment of the invention.

FIG. 7 depicts an elevation view of an exemplary roof escape assist handle in a retracted position, in accordance with an embodiment of the invention.

FIG. 8 depicts a perspective view of an exemplary spring-loaded mechanism of a roof escape assist handle, in accordance with an embodiment of the invention.

FIG. 9 depicts a top perspective view of an exemplary roof hatch system, in accordance with an embodiment of the invention.

FIG. 10 depicts a sectional, perspective view of an exemplary escape ladder in a ladder housing, in accordance with an embodiment of the invention.

FIG. 11 depicts a perspective view of an exemplary escape ladder in a partially deployed position, in accordance with an embodiment of the invention.

FIG. 12 depicts a perspective view of an exemplary escape ladder in a fully deployed position, in accordance with an embodiment of the invention.

### DETAILED DESCRIPTION OF PREFERRED EMBODIMENT(S)

Embodiments of the present technology provide a roof hatch system. More specifically, the present invention relates to a roof hatch system for school buses, trailers, and other large vehicles that provides ventilation and an emergency escape route when other egress routes are unusable or unavailable.

Aspects of the present invention provide a roof hatch system comprising a ladder system, illuminated handles, exterior grab handles, a push bar emergency release system, a ventilation system, and a weather seal to provide passengers with a prompt, efficient, safe escape option while also sealing a bus from weather conditions when the hatch is not in use.

The foregoing summary, as well as the following detailed description of certain embodiments will be better understood when read in conjunction with the appended drawings. It should be understood that the various embodiments are not limited to the arrangements and instrumentality shown in the drawings. It should also be understood that the embodiments may be combined, or that other embodiments may be utilized and that structural changes, unless so claimed, may be made without departing from the scope of the various embodiments of the present invention. The following detailed description is, therefore, not to be taken in a limiting sense, and the scope of the present invention is defined by the appended claims and their equivalents.

As used herein, an element or step recited in the singular and proceeded with the word “a” or “an” should be understood as not excluding plural of said elements or steps, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

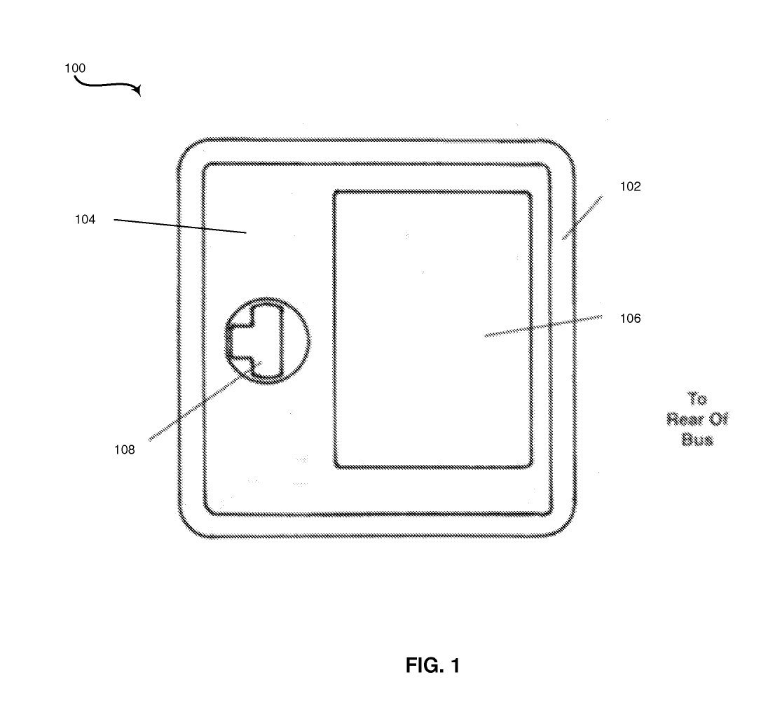

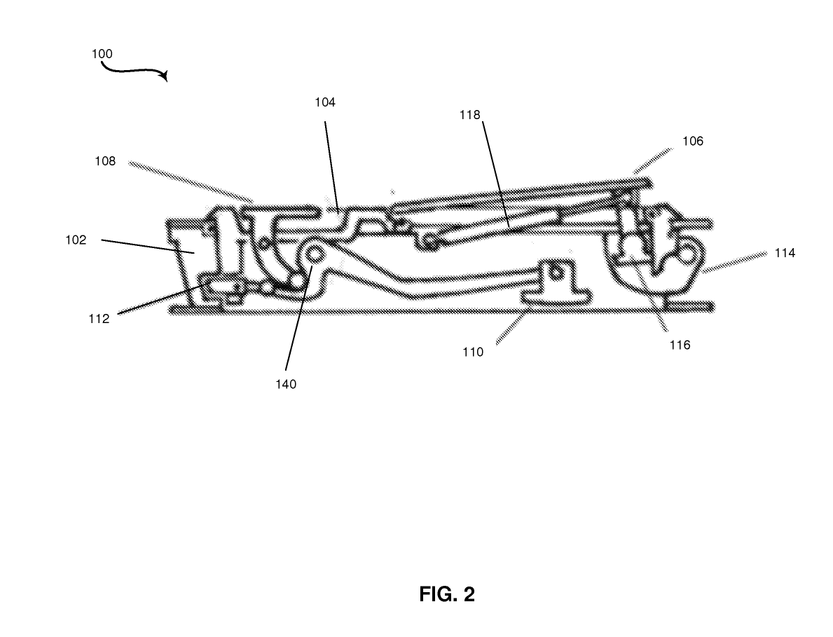

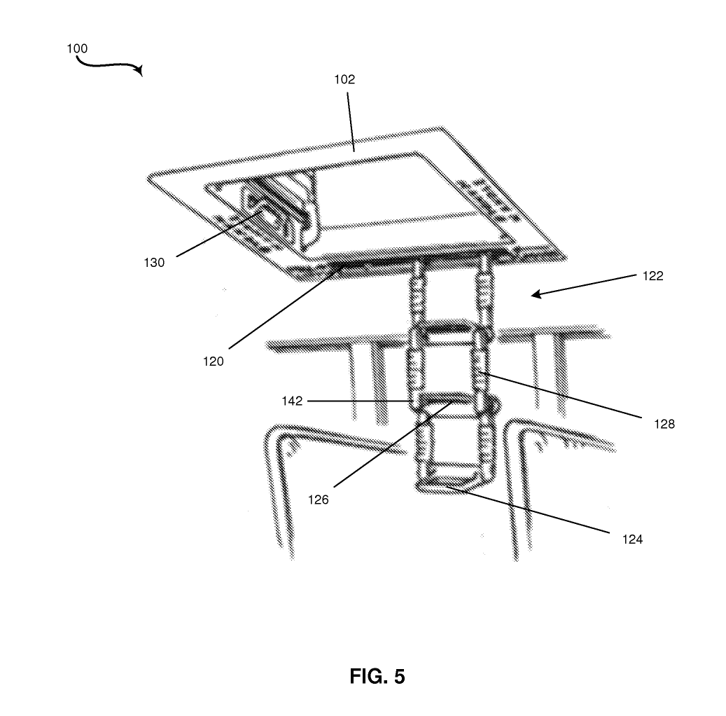

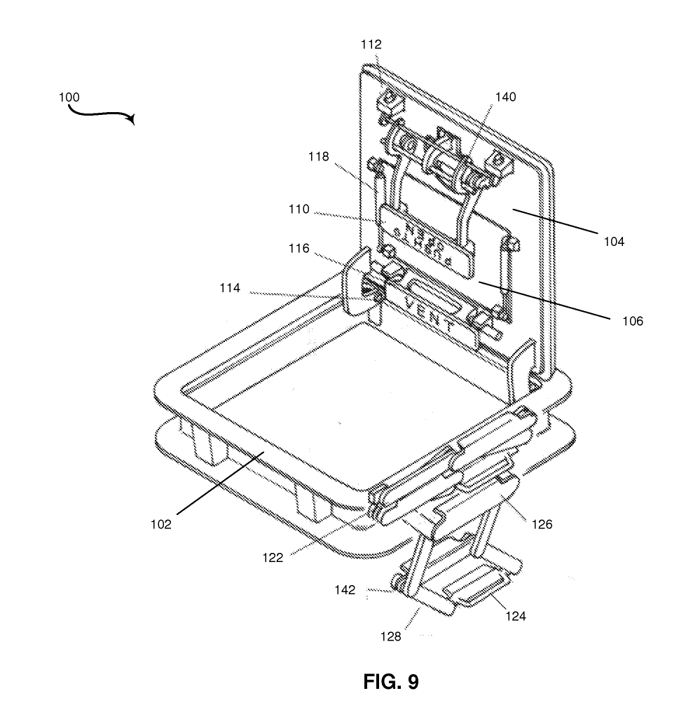

FIG. 1 depicts a top view of exemplary roof hatch system 100, in accordance with an embodiment of the invention. Referring to FIG. 1, the roof hatch system 100 comprises a housing 102 and a hatch 104. The housing 102 can be mounted within an opening in a roof of a vehicle, such as a bus, trailer, or the like. The hatch 104 may be coupled to the housing by hinges 114 (as illustrated in FIGS. 2-3 and 9, for example) such that the hatch 104 can be pivotable between a closed position within the housing 102, as illustrated in FIG. 1, and an open position, as illustrated in FIGS. 5 and 9, for example. The hatch 104 can comprise a vent 106 and an external hatch handle 108. The vent 106 can be pivotably coupled with a water seal within the hatch 104 at a highest point in the hatch system 100 to maximize the efficiency of the water seal by allowing water to run off of the vent 106 and roof hatch system 100 and onto the bus naturally. The vent 106 may be operable to provide ventilation when pivoted to an open position, as illustrated in FIG. 2, for example. The external hatch handle 108 can be a pull handle or any suitable handle operable to allow emergency respondents to easily open the hatch 104 and gain access to the bus, trailer, or any suitable vehicle.

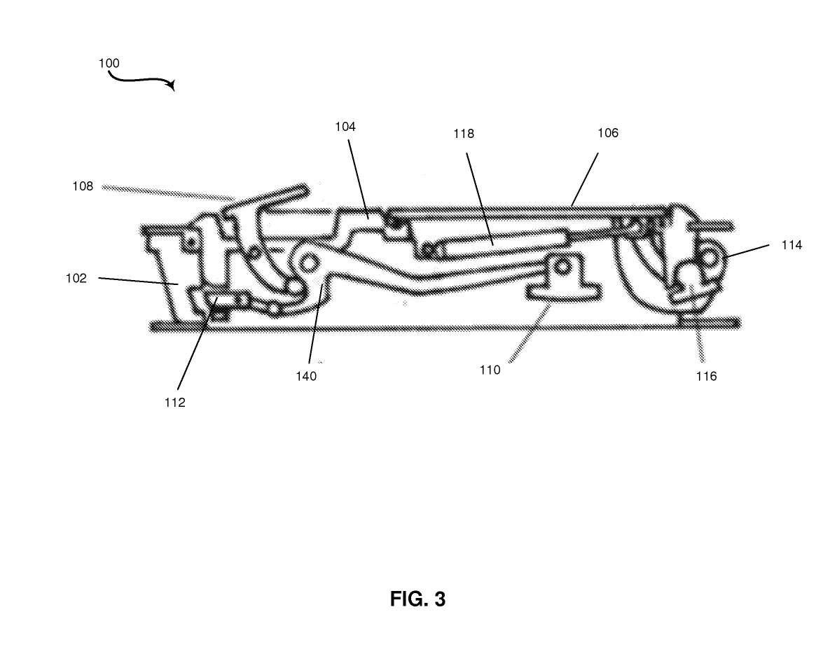

FIG. 2 depicts an elevation view of an exemplary roof hatch system 100 with an air ventilation vent 106 in an open position, in accordance with an embodiment of the invention. FIG. 3 depicts an elevation view of an exemplary roof hatch system 100 with an air ventilation vent 106 in a closed position and a hatch latch 112 in an open position, in accordance with an embodiment of the invention. Referring to FIGS. 2-3, the roof hatch system 100 comprises a housing 102 and a hatch 104. The hatch 104 may comprise a vent 106, an external hatch handle 108, an interior hatch bar 110, a hatch opening mechanism 140, a hatch latch 112, hinges 114, a vent handle 116, and a vent opening mechanism 118. The housing 102 can be mounted within an opening in a roof of a vehicle and may be pivotably coupled to the hatch 104 by hinges 114. In various embodiments, the hinges 114 may include a dampened motion spring to provide a safe, controlled opening and closing of the hatch 104.

The vent 106 may be operable to provide ventilation when the vent 106 is pivoted by a vent handle or bar 116 to an open position. The vent 106 may comprise a vent opening mechanism 118, such as pneumatic pistons that extend when pushed to open by the vent handle or bar 116. In various embodiments, the pneumatic pistons 118 may allow the vent 106 to close when it strikes something, which can prevent the roof hatch system 100 from breaking when a driver has mistakenly left the vent 106 open and drives under an object without proper clearance.

The external hatch handle 108 can be a pull handle or any suitable handle coupled to a hatch opening mechanism 140 operable to release a hatch latch 112 to allow emergency respondents to easily open the hatch 104 and gain access to the vehicle. The interior hatch bar 110 is coupled to the hatch opening mechanism 140 operable to release the hatch latch 112 to pivot the hatch 104 open when the hatch bar 110 is pushed from an interior of the vehicle. The push bar 110 opening system allows passengers to easily open the roof hatch 104, without hindrance or training, in a time efficient manner. The hatch opening mechanism 140 can be a lever mechanism or any suitable mechanism for releasing a latch 112 in response to pushing on the hatch bar 110 and/or pulling on the hatch handle 108, for example.

The roof hatch system 100 illustrated in FIGS. 2-3 share various characteristics with the roof hatch system 100 illustrated in FIG. 1 as described above.

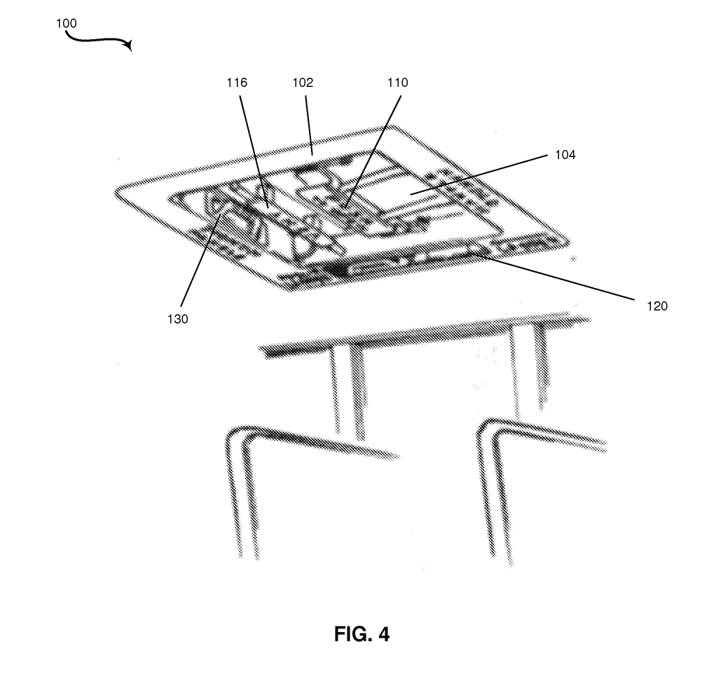

FIG. 4 depicts a bottom perspective view of an exemplary roof hatch system 100, in accordance with an embodiment of the invention. FIG. 5 depicts a bottom perspective view of an exemplary roof hatch system 100 with an escape ladder 122 deployed and a hatch 104 in an open position, in accordance with an embodiment of the invention. FIG. 9 depicts a top perspective view of an exemplary roof hatch system 100, in accordance with an embodiment of the invention.

Referring to FIGS. 4-5 and 9, the roof hatch system 100 comprises a housing 102 and a hatch 104. The hatch 104 comprises a vent 106, an interior hatch bar 110, a hatch opening mechanism 140, a hatch latch 112, hinges 114, a vent handle or bar 116, and a vent opening mechanism 118. The vent opening mechanism 118, such as pneumatic pistons or any suitable mechanism, is operable to extend or retract when a vent handle or bar 116 is pushed, pulled, and/or rotated to pivot the vent 106 between open and closed positions, as illustrated in FIGS. 2-3, for example. The vent opening mechanism 140 is operable to release or engage the hatch latch 112 when an interior hatch bar 110 is pushed or pulled, respectively, to pivot the hatch 104 between an open position, as illustrated in FIGS. 5 and 9, and a closed position, as illustrated in FIG. 4, for example. In various embodiments, the interior hatch bar 110 can include lighting, such as light emitting diode (LED) lighting or any suitable lighting to enable the interior hatch bar 110 to be easily identifiable in dark and/or smoke-filled vehicles.

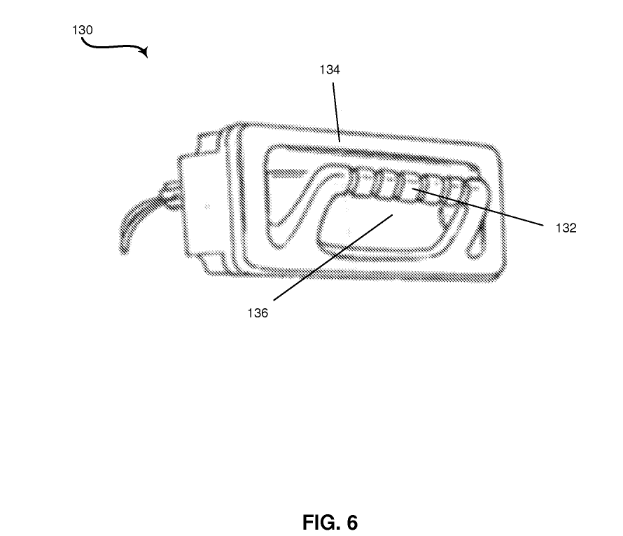

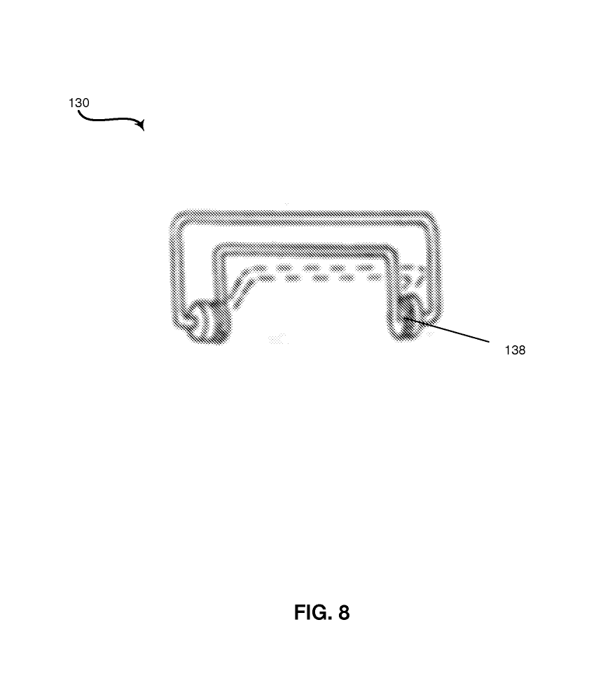

The housing 102 may be mounted within an opening in a roof of a vehicle and may be pivotably coupled to the hatch 104 by hinges 114. The housing 102 can comprise escape assist handles 130 and a roof ladder housing 120 for housing a retractable emergency egress ladder 122. As described below with regard to FIGS. 6-8, the escape assist handles 130 can provide assistance to passengers attempting to climb out of the roof hatch system 100. The escape assist handles 130 may include lighting, such as light emitting diode (LED) lighting or any suitable lighting to illuminate the handles 130 and roof hatch system 100. In various embodiments, the escape assist handles 130 can include a spring mechanism 138 (as illustrated in FIG. 8) enabling the handles 130 to pivot between an extended position that allows for easier access to the handles 130 and a retracted position that provides additional room for moving through an open hatch 104.

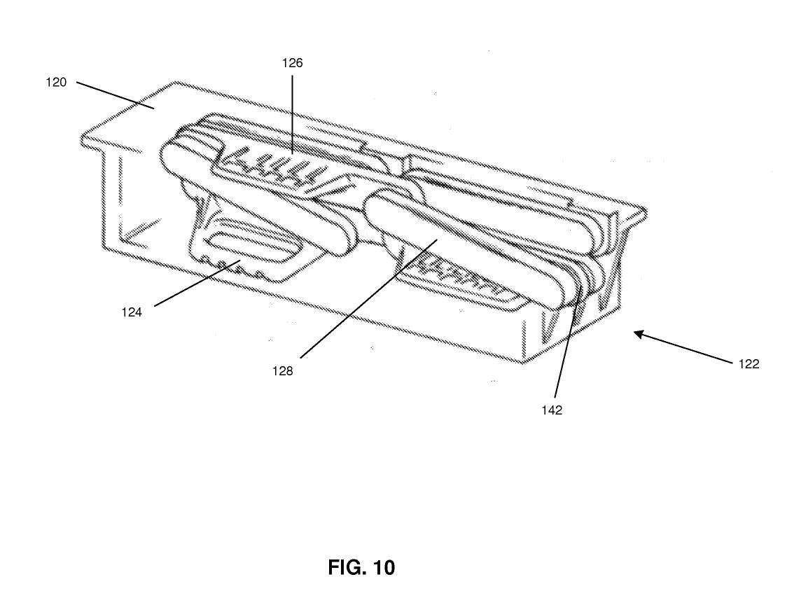

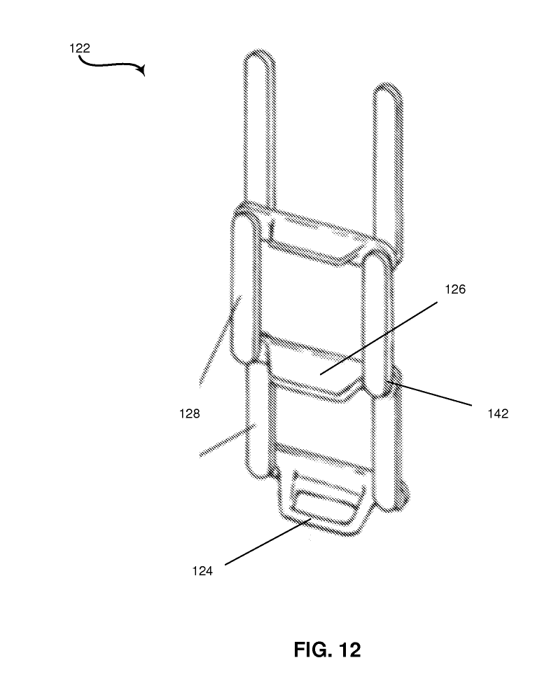

As described below with regard to FIGS. 10-12, the roof ladder housing 120 may house a retractable emergency egress ladder 122. The ladder 122 can be a spring loaded ladder that allows passengers to climb the ladder and gain access to safety without the need or ability to hoist their body weight out of an opening. The ladder 122 may be stored in a collapsed position within the housing 120. The ladder 122 can include a handle 124, steps 126, and risers 128. The steps 126 and risers 128 can be collapsibly coupled at dampened spring hinges 142 for slowing the deployment of the ladder 122 from a collapsed/stored position (as illustrated in FIG. 10, for example) to an open position (as illustrated in FIG. 12, for example). The handle 124 may include lighting, such as light emitting diode (LED) lighting or any suitable lighting to illuminate the pull handle 124 within the ladder housing 120. The handle 124 can be grasped and pulled to safely deploy the ladder 122. In various embodiments, the dampened spring hinges can call for approximately twenty to thirty pounds of downward force on the pull handle 124 to deploy the ladder 122 in a controlled manner to a fully extended position. The ladder 122 can allow shorter passengers to access the roof hatch bar 110 and provide assistance to passengers attempting to exit through the hatch 104, thereby eliminating the need to climb on bus seats or other passengers.

The roof hatch system 100 illustrated in FIGS. 4-5 and 9 share various characteristics with the roof hatch system 100 illustrated in FIGS. 1-3 as described above.

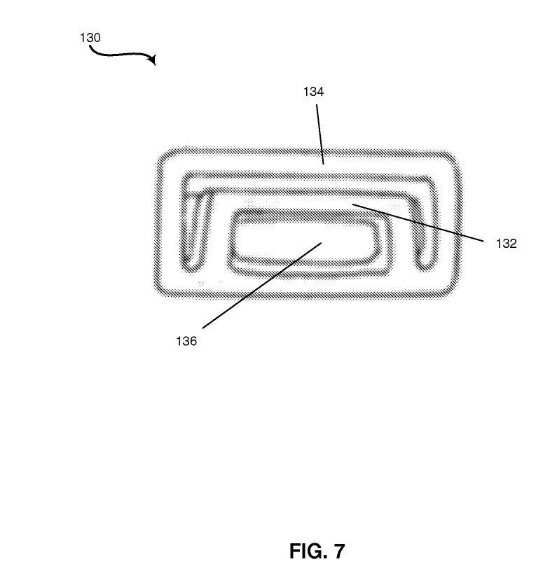

FIG. 6 depicts a perspective view of an exemplary roof escape assist handle 130 in an extended position, in accordance with an embodiment of the invention. FIG. 7 depicts an elevation view of an exemplary roof escape assist handle 130 in a retracted position, in accordance with an embodiment of the invention. FIG. 8 depicts a perspective view of an exemplary spring-loaded mechanism 138 of a roof escape assist handle 130, in accordance with an embodiment of the invention. Referring to FIGS. 6-8, the escape assist handle 130 can comprise a handle 132, a housing 134, an illuminated recess 136, and a spring-loaded mechanism 138. The spring-loaded mechanism 138 may be operable to pivot a handle 132 between an extended position that allows for easier access to the handle 132 and a retracted position that provides additional room for moving through an open hatch 104. For example, the spring-loaded mechanism can allow the handle 132 to regress back into the housing 134 if it is bumped by a passenger attempting to exit through the hatch 104, thereby preventing clothing or body parts from catching on the handle 132 and inhibiting the passenger from escaping. The handle 132 can be foam (e.g., medium-density self-skinning foam), plastic, metal, or any suitable material. In various embodiments, the handle 132 may be textured or provide any suitable mechanism that provides a grip for the handle 132. The housing 134 can be coupled with the roof hatch housing 102 and may provide an illuminated recess 136 for illuminating the handle 132 and roof hatch system 100.

The roof escape assist handle 130 illustrated in FIGS. 6-8 share various characteristics with the roof escape assist handle 130 illustrated in FIGS. 4-5 and 9 as described above.

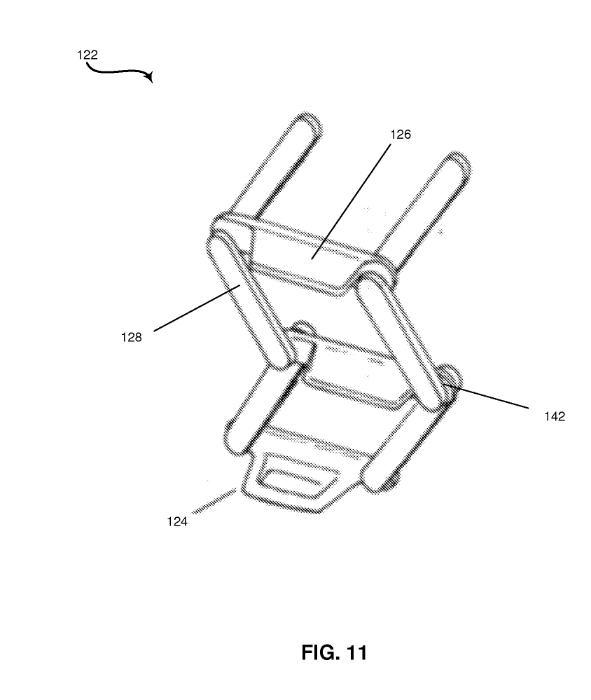

FIG. 10 depicts a sectional, perspective view of an exemplary escape ladder 122 in a ladder housing 120, in accordance with an embodiment of the invention. FIG. 11 depicts a perspective view of an exemplary escape ladder 122 in a partially deployed position, in accordance with an embodiment of the invention. FIG. 12 depicts a perspective view of an exemplary escape ladder 122 in a fully deployed position, in accordance with an embodiment of the invention. Referring to FIGS. 10-12, the ladder housing 120 can be integrated with or coupled to the hatch housing 102 (as illustrated in FIGS. 4-5 and 9, for example). The roof ladder housing 120 may house the retractable emergency egress ladder 122.

The ladder 122 can be a spring loaded ladder that allows passengers to climb the ladder and gain access to safety without the need or ability to hoist their body weight out of an opening. The ladder 122 may be stored in a collapsed position within the housing 120. The ladder 122 can include a handle 124, steps 126, and risers 128. The steps 126 and risers 128 can be collapsibly coupled at dampened spring hinges 142 for slowing the deployment of the ladder 122 from a collapsed/stored position to an open position. In various embodiments, the coupling of the steps 126 and risers 128 at the hinges 142 can include a lock or snap operable to secure the ladder 122 in the open position when the ladder 122 has been fully deployed. The handle 124 may include lighting, such as light emitting diode (LED) lighting or any suitable lighting to illuminate the pull handle 124 within the ladder housing 120. The handle 124 can be grasped and pulled to safely deploy the ladder 122. In various embodiments, the dampened spring hinges can call for approximately twenty to thirty pounds of downward force on the pull handle 124 to deploy the ladder 122 in a controlled manner to a fully extended position. In certain embodiments, the steps 126 and/or risers 128 can include a grip, such as rubber or any suitable material to provide passengers with a better grip of the risers 128 and to avoid feet from slipping from the steps 126, for example.

The escape ladder 122 and/or escape ladder housing 120 illustrated in FIGS. 10-12 share various characteristics with the escape ladder 122 and/or escape ladder housing 120 illustrated in FIGS. 4-5 and 9 as described above.

Aspects of the present invention provide a roof hatch system 100 that allows passengers a prompt, safe, and efficient escape alternative when normal methods of egress are blocked or unusable. In various embodiments, the roof hatch is completely illuminated, allowing passengers to easily find the roof hatch 104, even in dark or smoke-filled situations. Upon reaching the roof hatch system 100, passengers can pull down a collapsible ladder 122 from a ladder housing 120 integrated with or coupled to the hatch housing 102. The ladder 122 is secured by a spring mechanism 142 that provides, in certain embodiments, a pull-limit of approximately twenty (20) to thirty (30) pounds of downward force to pull the ladder 122 down. Once the ladder 122 is deployed, the roof hatch 104 can be opened by pushing on the emergency open bar 110. Once the hatch 104 is open, passengers can begin climbing out of the bus to safety. In various embodiments, interior illuminated grab handles 130 can be provided to assist passengers in climbing out of the bus. The grab handles 130 may include a spring system 138 allowing the handle 132 to regress back into a handle housing 134 if it is bumped. This allows larger passengers to climb through the hatch without the worry of clothing or body parts catching on the handle and inhibiting their escape.

In a representative embodiment, a roof hatch system 100 is provided. The roof hatch system 100 comprises a hatch housing 102, a hatch 104, a hatch latch 112, a hatch opening mechanism 140, and an interior hatch bar 110. The hatch 104 is pivotably coupled to the hatch housing 102 by at least one hinge 114. The hatch latch 112 is operable to detachably secure the hatch 104 to the hatch housing 102. The hatch opening mechanism 140 is operable to release the hatch latch 112. The interior hatch bar 110 is coupled to the hatch opening mechanism 140. The interior hatch bar 110 is operable to activate the hatch opening mechanism 140 in response to a received force toward the hatch 104 to pivot the hatch 104 from a closed position to an open position. In various embodiments, the interior hatch bar 110 is illuminated. In certain embodiments, the roof hatch system 100 includes a collapsible ladder system 120, 122 integrated with and/or coupled to the hatch housing 102. In a representative embodiment, the roof hatch system 100 includes an escape assist handle system 130.

While particular elements, embodiments and applications of the present invention have been shown and described, it will be understood that the invention is not limited thereto since modifications can be made by those skilled in the art without departing from the scope of the present disclosure, particularly in light of the foregoing teachings.

What is claimed is:

1. A roof hatch system comprising:
a hatch housing;
a hatch pivotably coupled to the hatch housing by at least one hinge;
a hatch latch operable to detachably secure the hatch to the hatch housing;
a hatch opening mechanism operable to release the hatch latch; and
an interior hatch bar coupled to the hatch opening mechanism, the interior hatch bar operable to activate the hatch opening mechanism in response to a received force toward the hatch to pivot the hatch from a closed position to an open position.

2. The roof hatch system according to claim 1, wherein the interior hatch bar comprises lighting.

3. The roof hatch system according to claim 1, wherein the at least one hinge comprises a dampened motion spring.

4. The roof hatch system according to claim 1, wherein the hatch comprises a vent having an interior portion and an exterior portion, the vent comprising:
a vent opening mechanism, and
at least one of a vent handle or a vent bar at the interior portion, the at least one of the vent handle or the vent bar operable to pivot the vent between an open position in response to a received force toward the vent and a closed position in response to a received force away from the vent.

5. The roof hatch system according to claim 4, wherein the vent opening mechanism comprises at least one pneumatic piston operable to extend to pivot the vent to the open position in response to the received force toward the vent and retract to pivot the vent to the closed position in response to the received force away from the vent.

6. The roof hatch system according to claim 5, wherein the at least one pneumatic piston is operable to retract and close the vent in response to a received force at the exterior portion of the vent when the vent is in an open position.

7. The roof hatch system according to claim 1, comprising an external hatch handle coupled to the hatch opening mechanism, the external hatch handle operable to activate the hatch opening mechanism to release the hatch latch.

8. The roof hatch system according to claim 1, wherein the hatch opening mechanism is a lever mechanism operable to release the hatch latch.

9. The roof hatch system according to claim 1, comprising:
a ladder housing at least one of coupled to and integrated with the hatch housing; and
a collapsible ladder coupled to the ladder housing, the collapsible ladder comprising:
risers,
steps, and
a pull handle operable to deploy the collapsible ladder from a collapsed position within the ladder housing to an open position where at least a portion of the collapsible ladder extends from the ladder housing,
wherein the risers and steps are collapsibly coupled at dampened hinges operable to slow deployment of the collapsible ladder from the collapsed position to the open position.

10. The roof hatch system according to claim 9, wherein the dampened hinges provide a pull-limit of twenty to thirty pounds of deployment force.

11. The roof hatch system according to claim 9, wherein the dampened hinges comprise at least one of a lock or a snap operable to secure the ladder in the open position.

12. The roof hatch system according to claim 1, comprising:
an escape assist handle system comprising:
a handle housing at least one of coupled to and integrated with the hatch housing,
an illuminated recess within the handle housing,
a handle pivotably coupled to the handle housing, and
a spring-loaded mechanism operable to pivot the handle between an extended position where the handle extends at least partially from the handle housing and a retracted position where the handle is within the handle housing.

13. The roof hatch system according to claim 12, wherein the spring-loaded mechanism is operable to regress the handle into the handle housing in response to a received force at the handle.

14. A roof hatch system comprising:
a hatch housing;
a ladder housing at least one of coupled to and integrated with the hatch housing; and
a collapsible ladder coupled to the ladder housing, the collapsible ladder comprising:
risers,
steps, and
a pull handle operable to deploy the collapsible ladder from a collapsed position within the ladder housing to an open position where at least a portion of the collapsible ladder extends from the ladder housing.

15. The roof hatch system according to claim 14, wherein the risers and steps are collapsibly coupled at dampened hinges operable to slow deployment of the collapsible ladder from the collapsed position to the open position.

16. The roof hatch system according to claim 15, wherein the dampened hinges provide a pull-limit of twenty to thirty pounds of deployment force.

17. The roof hatch system according to claim 15, wherein the dampened hinges comprise at least one of a lock and a snap operable to secure the ladder in the open position.

18. The roof hatch system according to claim 14, wherein the pull handle is illuminated.

19. A roof hatch system comprising:
a hatch housing; and
an escape assist handle system comprising:
a handle housing at least one of coupled to and integrated with the hatch housing,
an illuminated recess within the handle housing,
a handle pivotably coupled to the handle housing, and
a spring-loaded mechanism operable to pivot the handle between an extended position where the handle extends at least partially from the handle housing and a retracted position where the handle is within the handle housing.

20. The roof hatch system according to claim 19, wherein the spring-loaded mechanism is operable to regress the handle into the handle housing in response to a received force at the handle.
